(19) United States
(12) Patent Application Publication
(10) Pub. No.: US 2002/0175250 A1
(43) Pub. Date: Nov. 28, 2002

(54) Fixation seat capable of being attached firmly to wall

(76) Inventor: Bing-Tson Lian, Taichung (TW)

Correspondence Address: HARRISON & EGBERT, 412 MAIN STREET, 7TH FLOOR, HOUSTON, TX, 77002, US

(21) Appl. No.: 09/862,327

(22) Filed: May 23, 2001

(51) Int. Cl. A45D 42/14; F16B 47/00

(52) U.S. Cl. 248/205.5

(57) ABSTRACT

A fixation seat comprises a profiling member, a suction cup, a spring, and an adjustment member. The profiling member has an annular groove and a center through hole. The suction cup has an annular protrusion and a threaded rod fastened therewith. The suction cup is joined with the profiling member such that the annular protrusion of the suction cup is received in the annular groove of the profiling member, and that the threaded rod is put through the center through hole of the profiling member. The spring is fitted over the threaded rod. The adjustment member has a threaded through hole by which the adjustment member is rotatably engaged with the threaded rod. As the adjustment member is turned on the threaded rod to compress the spring, the suction cup is caused by tension to attach firmly to wall.

### BACKGROUND OF THE INVENTION

1. Field of the Invention

The present invention relates generally to a fixation means, and more particularly to a fixation seat which is provided with a means to attach the fixation seat firmly to the wall.

2. Description of Related Art

The conventional ways of fixing an object to the wall surface involve the use of fastening screws, adhesive, suction cup, etc. The fastening screws often disfigure the wall surface to which the object is attached. The object can not be securely fixed to the wall surface by an adhesive. The conventional suction cups are generally defective in design in that they are apt to deform or harden, especially when the suction cups are used in a place where temperature and humidity fluctuate severely.

### BRIEF SUMMARY OF THE INVENTION

The primary objective of the present invention is to provide a fixation seat which can be attached easily and firmly to a wall surface.

The fixation seat of the present invention comprises a profiling member, a suction cup, a spring, and an adjustment member. The profiling member serves to give a specified profile to the fixation seat of the present invention. The suction cup is disposed under the profiling member and is capable of sticking to a wall surface by creating a vacuum in the area it covers. The suction cup is provided at the center with a threaded rod fastened thereto. The adjustment member is provided with a threaded through hole engageable with the threaded rod. The adjustment member is rotatably fastened with the threaded rod in conjunction with the spring which is fitted over the threaded rod and is located between the profiling member and the adjustment member.

The features, functions, and advantages of the present invention will be more readily understood upon a thoughtful deliberation of the following detailed description of a preferred embodiment of the present invention with reference to the accompanying drawings.

### BRIEF DESCIPTION OF THE SEVERAL VIEWS OF THE DRAWINGS

FIG. 1 shows a perspective view of the preferred embodiment of the present invention.

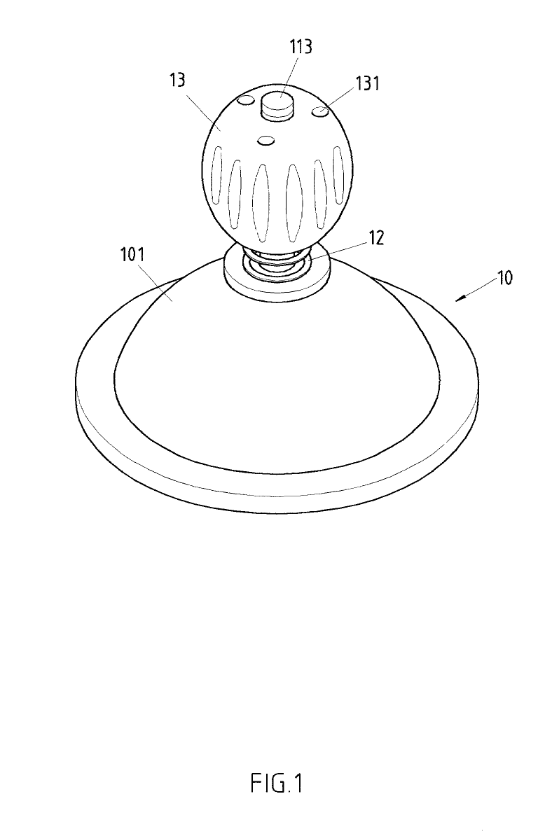

FIG. 2 shows an exploded view of the preferred embodiment of the present invention.

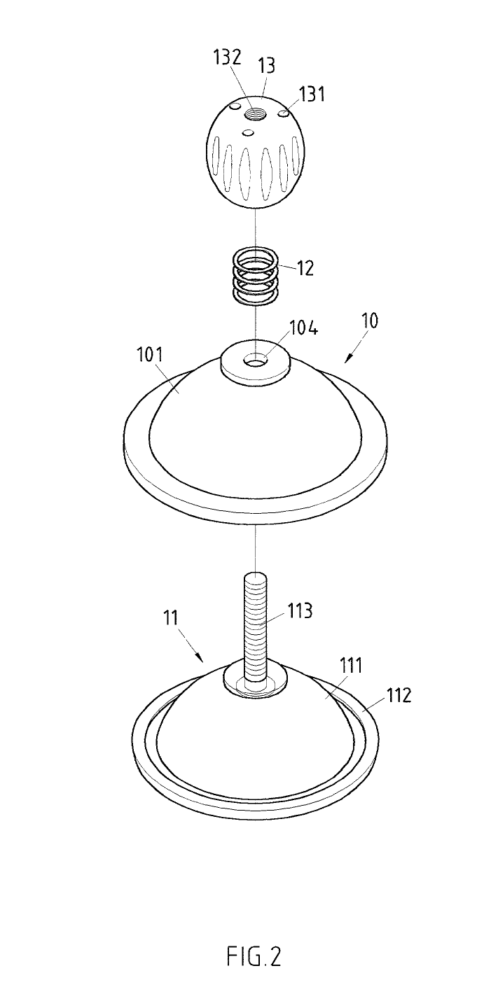

FIG. 3 shows an internal view of the profiling member of the preferred embodiment of the present invention.

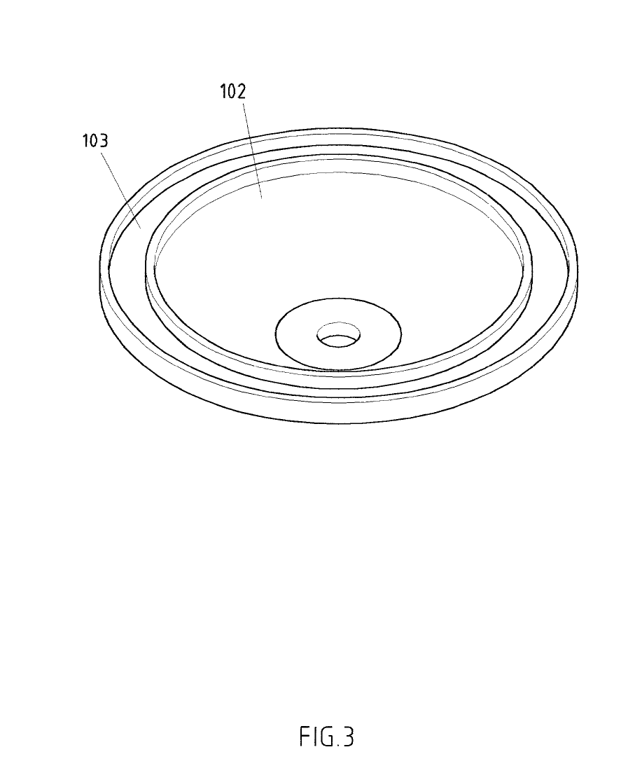

FIG. 4 shows a longitudinal sectional view of the preferred embodiment of the present invention in combination.

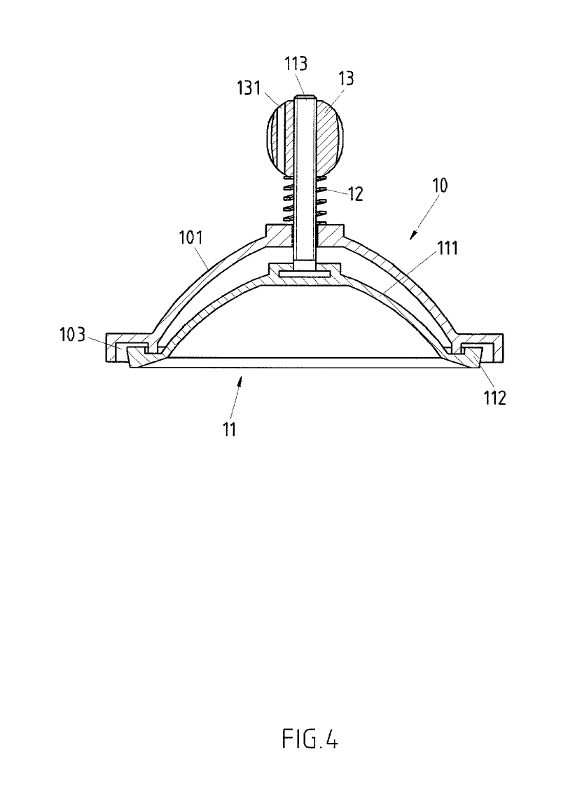

FIG. 5 shows a longitudinal sectional schematic view of the preferred embodiment of the present invention at work.

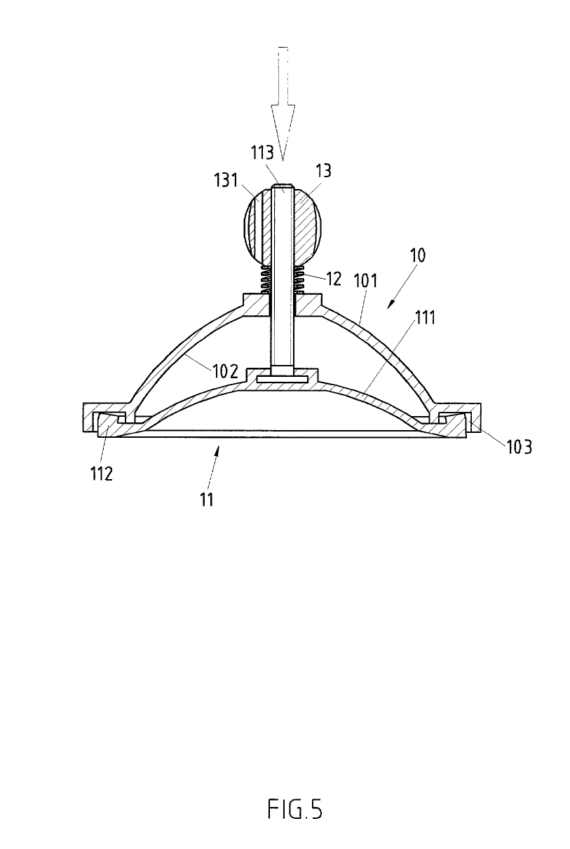

FIG. 6 shows another longitudinal sectional schematic view of the preferred embodiment of the present invention at work.

FIG. 7 shows a schematic view of the preferred embodiment of the present invention serving as a rack.

### DETAILED DESCRIPTION OF THE INVENTION

As shown in all drawings provided herewith, a fixation seat embodied in the present invention comprises a profiling member 10, a rubber suction cup 11, a spring 12, and an adjustment member 13.

The profiling member 10 is of a dome-shaped construction and is provided in the internal side with a bowl-shaped recess 102 and an annular groove 103 extending along the fringe of the bowl-shaped recess 102. The profiling member 10 has an external side 101 which is provided at the center with a through hole 104.

The suction cup 11 is made of a rubber material. The suction cup 111 has an external side 111 which is of a dome-shaped construction and is provided with an annular protrusion 112 extending along the fringe of the external side 111. The annular protrusion 112 is corresponding in location to the annular groove 103 of the profiling member 10. The suction cup 11 is provided at the center of the external side 111 thereof with a threaded rod 113 fastened at one end thereto. The spring 12 is fitted over the threaded rod 113.

The adjustment member 13 is provided with a threaded through hole 132 engageable with the threaded rod 113. The adjustment member 13 is further provided with a plurality of insertion holes 131 and a knurled outer surface to make the adjustment member 13 skidproof.

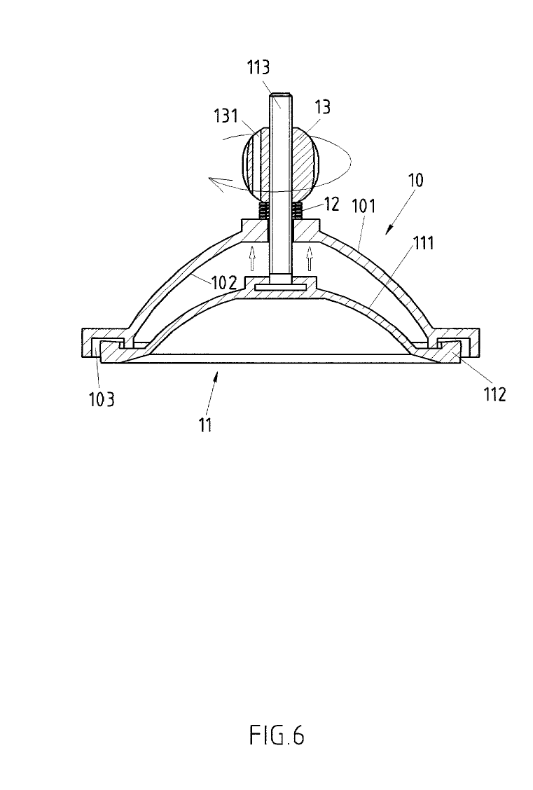

In combination, the suction cup 11 is joined with the profiling member 10 such that the annular protrusion 112 of the suction cup 11 is received in the annular groove 103 of the profiling member 10, and that the threaded rod 113 is put through the through hole 104 of the profiling member 10. The spring 12 is fitted over the threaded rod 113 and is located between the profiling member 10 and the adjustment member 13 whose threaded through hole 132 is rotatably engaged with the threaded rod 113. As the adjustment member 13 is turned on the threaded rod 113, the spring 12 is compressed, thereby causing the suction cup 11 to be raised, as illustrated in FIG. 6. The tension of the raised suction cup 11 causes the suction cup 11 to be attached firmly to a surface.

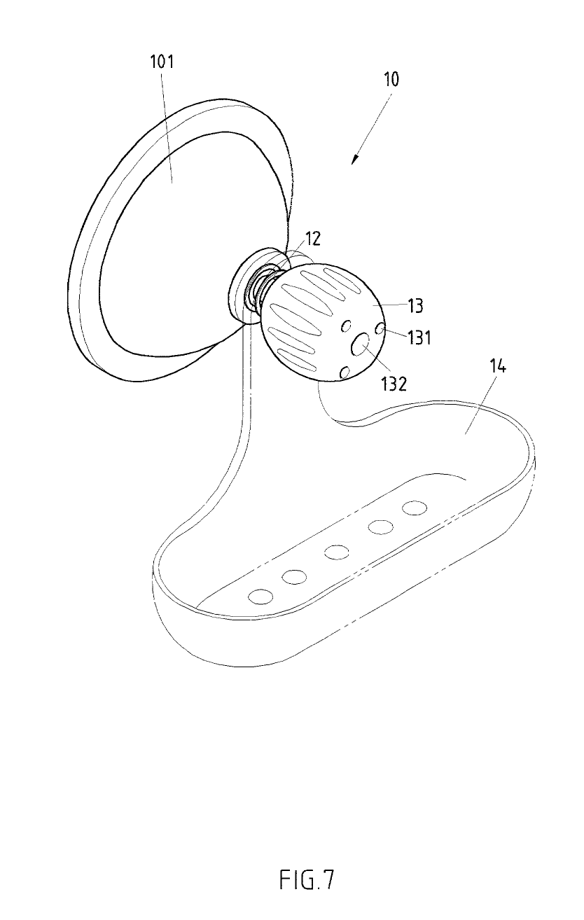

The fixation seat of the preferred embodiment of the present invention can be used to hold a rack 14, as illustrated in FIG. 7. The rack 14 is held between the adjustment member 13 and the profiling member 10.

The embodiment of the present invention described above is to be regarded in all respects as being merely illustrative and not restrictive. Accordingly, the present invention may be embodied in other specific forms without deviating from the spirit thereof. The present invention is therefore to be limited only by the scope of the following claim.

I claim:

1. A fixation seat capable of being attached firmly to a surface, said fixation seat comprising:
a profiling member of a dome-shaped construction and provided in an internal side with a bowl-shaped recess and an annular groove extending along the fringe of said bowl-shaped recess, said profiling member further provided in an external side with a center through hole;
a suction cup having a dome-shaped external side which is provided with an annular protrusion extending along the fringe thereof, said external side further provided at the center with a threaded rod fastened at one end thereto, said suction cup being joined with said profiling member in such a manner that said annular protrusion of said suction cup is received in said annular groove of said profiling member, and that said threaded rod is put through said center through hole of said profiling member;
a spring fitted over said threaded rod; and
an adjustment member provided with a threaded through hole and rotatably fastened with said threaded rod such that said threaded through hole of said adjustment member is engaged with said threaded rod, and that said spring is located between said adjustment member and said profiling member whereby said adjustment member is turned on said threaded rod to compress said spring so as to raise said suction cup to result in tension enabling said suction cup to attach firmly to the surface.
